(19) United States
(12) Patent Application Publication
(10) Pub. No.: US 2026/0361034 A1
(43) Pub. Date: Nov. 12, 2026

(54) STRUCTURE OF ELECTRICAL CONNECTOR

(71) Applicant: ACES ELECTRONICS CO., LTD., Taoyuan City (TW)

(72) Inventors: Kuo-Hua HUANG, Taoyuan City (TW); Chu-Cheng WU, Taoyuan City (TW)

(21) Appl. No.: 19/313,032

(22) Filed: Aug. 28, 2025

(30) Foreign Application Priority Data
May 7, 2025 (TW) 114204584

(51) Int. Cl. H01R 13/6471

(52) U.S. Cl. CPC H01R 13/6471

(57) ABSTRACT

A structure of electrical connector includes an insulating body, and a first terminal set and a second terminal set disposed opposite to each other in the insulating body. The first terminal set and the second terminal set each include a plurality of signal terminals and a plurality of ground terminals. The signal and ground terminals each have a connecting portion and a welding portion respectively located at two opposite ends. Each signal terminal further has a wider base portion and a wider fixing portion located between the connecting portion and the welding portion. The base portions and the fixing portions of the adjacent signal terminals form a staggered structure. The above can increase the physical distance between the adjacent signal terminals, and the farther distance between the signal terminals can reduce the far-end crosstalk during high-frequency transmission.

This application claims the priority benefit of Taiwan patent application number 114204584, filed on May 7, 2025.

### BACKGROUND OF THE INVENTION

### 1. Field of the Invention

The present invention relates to an electrical connector technology, in particular to a structure of electrical connector in which the base portions and the fixing portions of the adjacent signal terminals of the first terminal set and the second terminal set of the electrical connector form a staggered structure, which can increase the physical distance between the adjacent signal terminals. The farther the distance between the signal terminals, the lower the far-end crosstalk during high-frequency transmission, so as to achieve the purpose of manufacturing an electrical connector structure with better high-frequency transmission characteristics.

### 2. Description of the Related Art

Today, the electronics industry is growing and maturing rapidly. Many different 3C functional electronic products are developed and manufactured according to different needs. In particular, the alternate, change speed of computers, laptops, tablets and smartphones is beyond imagination. The direction of the update is nothing more than processor computing speed, network transmission speed and lighter, thinner, shorter and smaller size. In addition to being smaller in size, electronic products also need to be equipped with different interface connectors to accommodate the expansion of more functions.

Furthermore, the miniaturization of electronic products is largely due to the advancement of wafer manufacturing processes. When the circuit board and the corresponding connector are miniaturized, the distance between the terminals of the terminal sets is too close, and electromagnetic waves and cross-talk interference are generated when transmitting high-frequency signals. The cross-talk interference problem has an absolute impact on the transmission signal speed. The high-frequency connector includes an insulating body, differential signal terminals inserted into the insulating body, and ground terminals adjacent to the differential signal terminals. The spacing of the differential signal terminals must be kept consistent throughout the entire trace. Otherwise, the spacing variation will cause unbalanced magnetic field coupling, thereby reducing the effect of magnetic field cancellation and causing the increase in electromagnetic interference (EMI). The biggest impact of the increase in electromagnetic interference is that it increases the attenuation value of the transmission signal of the differential signal terminals, thereby reducing the speed of the transmission signal of the differential signal terminals. Furthermore, it is known that the specifications of the multiple conductive terminals are the same, so the arranging structure and bending angle of the adjacent differential signal terminals are also the same. This configuration of the differential signal terminals is not conducive to high-frequency transmission and forms far-end crosstalk. The defects caused by the aforementioned known differential signal terminals need to be researched and improved by those in the industry.

### SUMMARY OF THE INVENTION

Therefore, in view of the above problems and deficiencies, the inventor collected relevant information and, after multiple evaluations and considerations, designed the invention of this structure of electrical connector.

The main object of the present invention is to provide an electrical connector, which comprises an insulating body, and a first terminal set and a second terminal set disposed opposite to each other in the insulating body. The first terminal set and the second terminal set each comprise a plurality of signal terminals and a plurality of ground terminals. Each terminal of the signal terminals and the ground terminals comprises a connecting portion and a welding portion at both ends. Each terminal of the signal terminals further comprises a wider base portion and a wider fixing portion between the connecting portion and the welding portion, and the base portions and the fixing portions of the adjacent signal terminals form a staggered structure. By forming a staggered structure of the base portions and the fixing portions of the adjacent signal terminals of the first terminal set and the second terminal set, the physical distance between the adjacent signal terminals can be increased. The farther distance between the signal terminals can reduce the far-end crosstalk during high-frequency transmission, thereby achieving the purpose of producing an electrical connector structure with better high-frequency transmission characteristics.

Another object of the present invention is that the insulating body comprises a holder base, two plates located on one side of the holder base, a receiving cavity formed inside the holder base, a docking space formed between the two plates, a plurality of through slots formed between the holder base and the two plates for the first terminal set and the second terminal set to pass through, and a plurality of positioning grooves provided in the two plates for accommodating and positioning the connecting portions of the first terminal set and the second terminal set.

Still another object of the present invention is that the electrical connector further comprises a first terminal block, wherein the first terminal set is inserted into the first terminal block; the first terminal set has the connecting portions thereof with a longer length and inserted into the respective through slots of the insulating body and the welding portions thereof with a shorter length located on two opposite sides of the first terminal block; the wider base portions of the first terminal set are located between the respective connecting portions and the first terminal block; the fixing portions of the first terminal set are embedded in the first terminal block; the signal terminals of the first terminal set are classified into a plurality of first signal terminals, a plurality of second signal terminals and a plurality of third signal terminals; first ground terminals of the first terminal set are respectively provided on two opposite sides of the first signal terminals, the second signal terminals and the third signal terminals; the first terminal block comprises a plurality of hollow portions corresponding to the signal terminals of the first terminal set, and a plurality of recessed grooves at an inner side thereof corresponding to the first ground terminals of the first terminal set.

Still another object of the present invention is that the electrical connector further comprises a second terminal block, wherein the second terminal set is inserted into the second terminal block; the second terminal set has the connecting portions thereof with a longer length and inserted into the respective through slots of the insulating body and the welding portions thereof with a shorter length located on two opposite sides of the second terminal block; the wider base portions of the second terminal set are located between the respective connecting portions and the second terminal block; the fixing portions of the second terminal set are embedded in the second terminal block; the signal terminals of the second terminal set are classified into a plurality of fourth signal terminals, a plurality of fifth signal terminals and a plurality of sixth signal terminals; second ground terminals of the second terminal set are respectively provided on two opposite sides of the fourth signal terminals, the fifth signal terminals and the sixth signal terminals; the second terminal block comprises a plurality of hollow portions corresponding to the signal terminals of the second terminal set, and a plurality of recessed grooves located at an inner side thereof corresponding to the second ground terminals of the second terminal set.

Still another object of the present invention is that the electrical connector further comprises a plurality of conductive plastics disposed between the first terminal set and the second terminal set, and the plurality of conductive plastics are all provided with abutment portions protrudingly coupled to the ground terminals of the first terminal set and the second terminal set, and air gaps formed adjacent to the signal terminals of the first terminal set and the second terminal set and between the adjacent plurality of conductive plastics.

### BRIEF DESCRIPTION OF THE DRAWINGS

FIG. 1 is a three-dimensional external view of the electrical connector of the present invention.

FIG. 2 is a three-dimensional external view of the electrical connector of the present invention from another viewing angle.

FIG. 3 is a three-dimensional exploded view of the electrical connector of the present invention.

FIG. 4 is a three-dimensional exploded view of the electrical connector of the present invention from another viewing angle.

FIG. 5 is a side cross-sectional view of the electrical connector of the present invention.

FIG. 6 is a three-dimensional structural view of the first terminal set of the present invention.

FIG. 7 is a three-dimensional structural view of the second terminal set of the present invention.

### DETAILED DESCRIPTION OF THE PREFERRED EMBODIMENT

In order to achieve the above-mentioned purpose and effect, the technical means and structure adopted by the present invention are described in detail with reference to the preferred embodiment of the present invention, and its features and functions are as follows for a complete understanding.

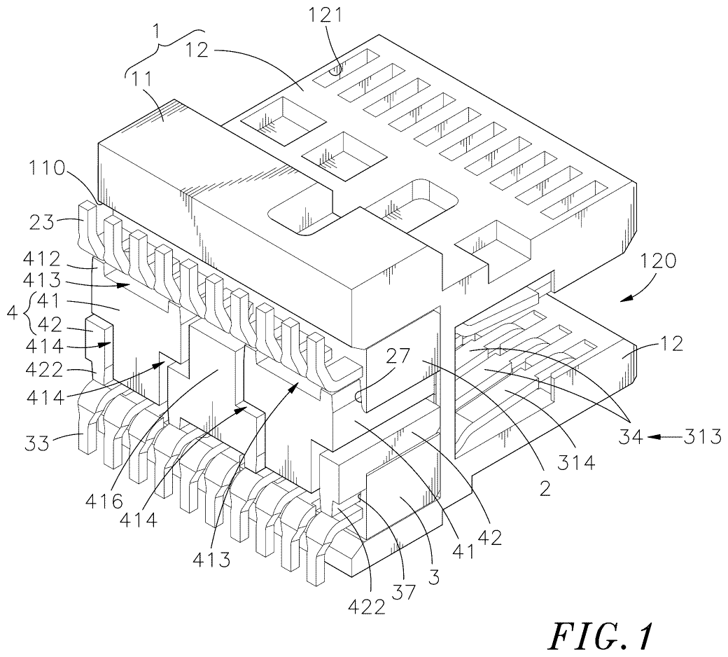

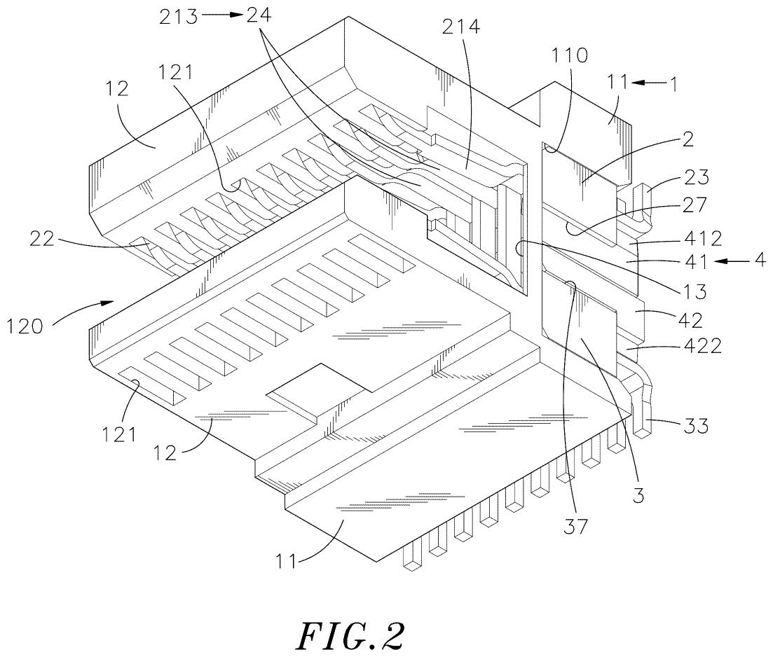

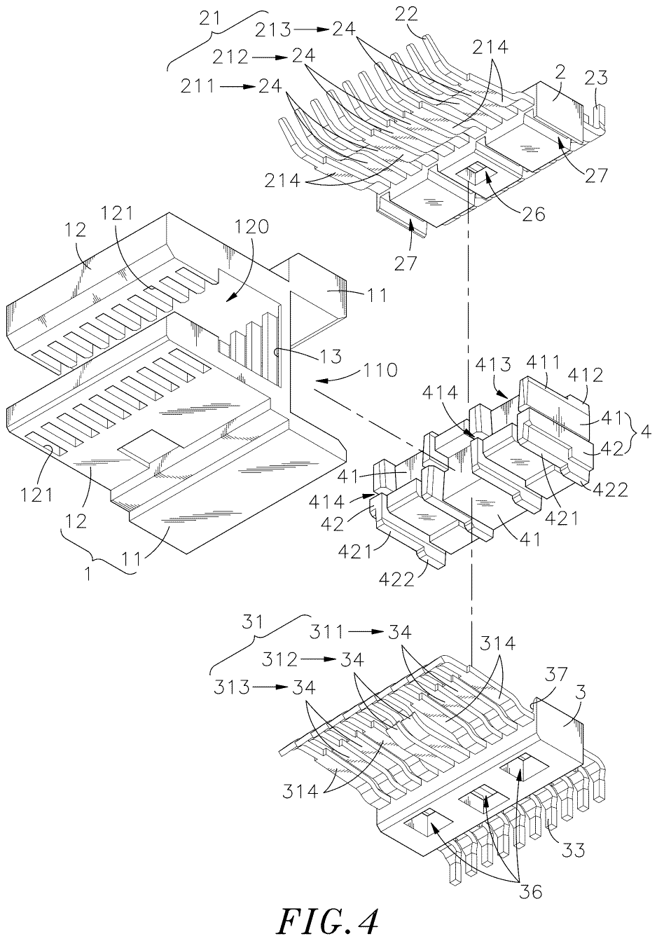

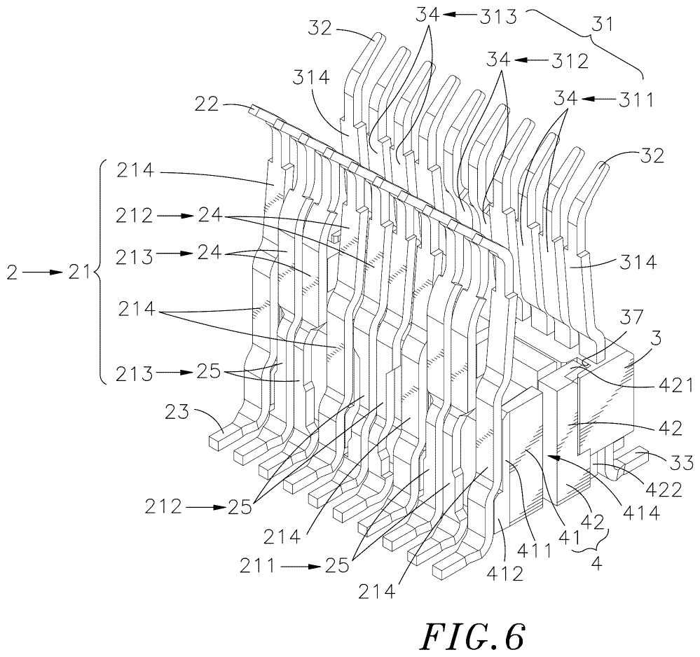

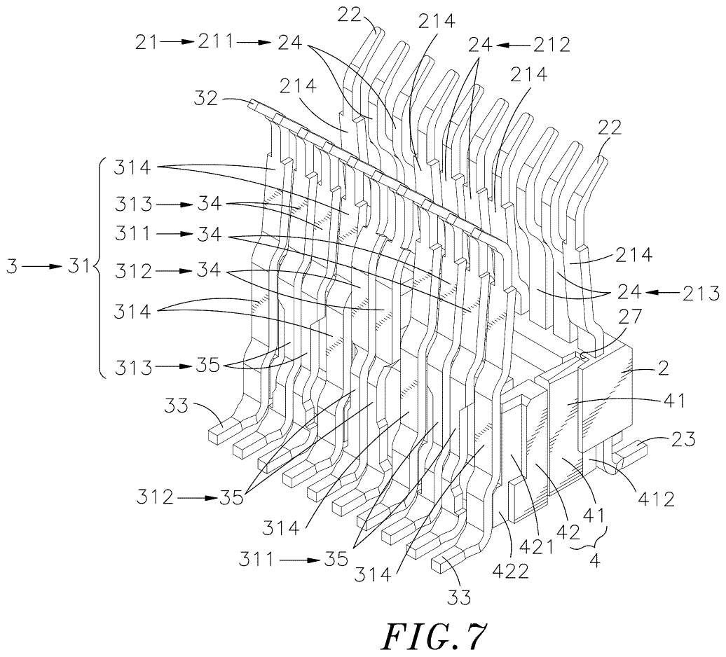

Please refer to FIGS. 1 to 4, 6 and 7, which are respectively a three-dimensional external view of the electrical connector of the present invention, a three-dimensional external view of the electrical connector of the present invention from another viewing angle, a three-dimensional exploded view of the electrical connector of the present invention, a three-dimensional exploded view of the electrical connector of the present invention from another viewing angle, a three-dimensional structural view of the first terminal set of the present invention and a three-dimensional structural view of the second terminal set of the present invention. As can be clearly seen from the figures, the main components and features of the electrical connector of the present invention are described in detail as follows:

The electrical connector comprises an insulating body 1, in which a first terminal set 21 and a second terminal set 31 are disposed opposite to each other. The first terminal set 21 and the second terminal set 31 each comprise a plurality of signal terminals and a plurality of ground terminals. Each terminal of the signal terminals and the ground terminals comprises a connecting portion (22, 32) and a welding portion (23, 33) at both ends. Each terminal of the signal terminals further comprises a wider base portion (24, 34) and a wider fixing portion (25, 35) between the connecting portion (22, 32) and the welding portion (23, 33), and the base portions (24, 34) and the fixing portions (25, 35) of the adjacent signal terminals form a staggered structure. The terminals of the first terminal set 21 and the second terminal set 31 in a relative state may be arranged up and down or left and right.

The above-mentioned insulating body 1 comprises a holder base 11, two plates 12 located on one side of the holder base 11, a receiving cavity 110 formed inside the holder base 11, a docking space 120 formed between the two plates 12, a plurality of through slots 13 formed between the holder base 11 and the two plates 12 for the first terminal set 21 and the second terminal set 31 to pass through, and a plurality of positioning grooves 121 provided in the two plates 12 for accommodating and positioning the connecting portions (22, 32) of the first terminal set 21 and the second terminal set 31.

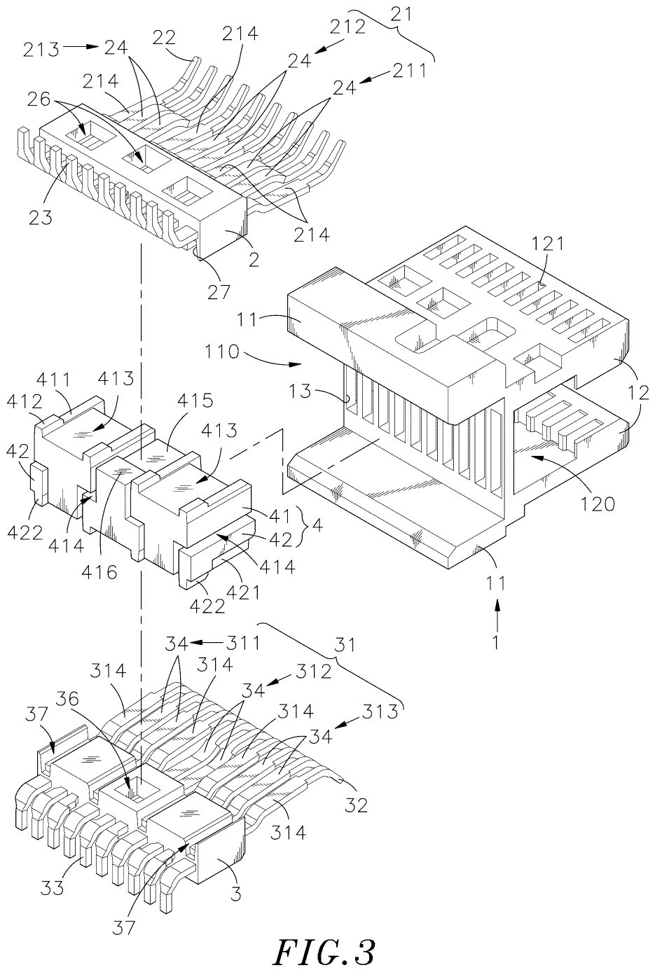

Please refer to FIGS. 3, 4, and 6, in which the first terminal set 21 is inserted into a first terminal block 2, and the first terminal set 21 has the connecting portions 22 thereof with a longer length and inserted into the through slots 13 of the insulating body 1 and the welding portions 23 thereof with a shorter length on both sides of the first terminal block 2. The wider base portions 24 of the first terminal set 21 are located between the respective connecting portions 22 and the first terminal block 2. The fixing portions 25 of the first terminal set 21 are embedded in the first terminal block 2. The first terminal set 21 includes first signal terminals 211, second signal terminals 212 and third signal terminals 213. In a preferred embodiment, the base portions 24 and the fixing portions 25 of the first signal terminals 211 and the third signal terminals 213 are bent outward, while the base portions 24 and the fixing portions 25 of the second signal terminals 212 are bent inward, so as to form a staggered structure of the base portions 24 and the fixing portions 25 of the adjacent signal terminals. First ground terminals 214 are provided on both sides of the first signal terminals 211, the second signal terminals 212 and the third signal terminals 213. The first terminal block 2 is formed with a plurality of hollow portions 26 corresponding to the signal terminals (211, 212, 213) of the first terminal set 21, and the first terminal block 2 is also formed with a plurality of recessed grooves 27 at the inner side thereof corresponding to the first ground terminals 214 of the first terminal set 21.

Please refer to FIGS. 3, 4, and 7, in which the second terminal set 31 is inserted into a second terminal block 3, and the second terminal set 31 has the connecting portions 32 thereof with a longer length and inserted into the through slots 13 of the insulating body 1 and the welding portions 33 thereof with a shorter length on both sides of the second terminal block 3. The wider base portions 34 of the second terminal set 31 are located between the respective connecting portions 32 and the second terminal block 3. The fixing portions 35 of the second terminal set 31 are embedded in the second terminal block 3. The second terminal set 31 includes fourth signal terminals 311, fifth signal terminals 312 and sixth signal terminals 313. In a preferred embodiment, the base portions 34 and the fixing portions 35 of the fourth signal terminals 311 and the sixth signal terminals 313 are bent inward, while the base portions 34 and the fixing portions 35 of the fifth signal terminals 312 are bent outward, so as to form a staggered structure of the base portions 34 and the fixing portions 35 of the adjacent signal terminals. Second ground terminals 314 are provided on both sides of the fourth signal terminals 311, the fifth signal terminals 312 and the sixth signal terminals 313. The second terminal block 3 is formed with a plurality of hollow portions 36 corresponding to the signal terminals (311, 312, 313) of the second terminal set 31, and the second terminal block 3 is also formed with a plurality of recessed grooves 37 at the inner side thereof corresponding to the second ground terminals 314 of the second terminal set 31.

A plurality of conductive plastics 4 disposed between the first terminal set 21 and the second terminal set 31 are all provided with abutment portions protrudingly coupled to the ground terminals (214, 314), and air gaps are formed adjacent to the signal terminals (211, 212, 213, 311, 312, 313) and between adjacent the plurality of conductive plastics 4. The first conductive plastics 41 are generally in a “ [symbol] ” shape with a wider part and a narrower part, each comprising two first engaging portions 411 respectively provided on two opposite sides of the bottom surface of the wider part thereof to be inserted into the recessed grooves (27, 37) of the first terminal block 2 or the second terminal block 3, a first abutting portion 412 with a larger protrusion height formed at one end of each of the two first engaging portions 411 and coupled to the ground terminals (214, 314), a terminal air gap 413 in a recessed shape formed between the two first engaging portions 411, a channel air gap 414 formed on two sides of the narrower part of the first conductive plastics 41, and a contact surface 415 and a positioning portion 416 with a greater height formed on the top surface of the narrower part of the first conductive plastics 41. The second conductive plastics 42 are generally in a long strip shape, each comprising a second engaging portion 421 provided on the bottom side thereof to be inserted into one respective recessed groove (27, 37) of the first terminal block 2 or the second terminal block 3, a second abutting portion 422 with a larger protrusion height formed at one end of the second engaging portion 421 and coupled to the ground terminals (214, 314). The preferred method for joining the first engaging portions 411 of the first conductive plastics 41, the second engaging portion 421 of the second conductive plastics 42 and the recessed grooves (27, 37) is to form a fixed structure through ultrasonic welding.

After the first terminal block 2, the second terminal block 3 and the plurality of conductive plastics 4 of the electrical connector are placed in the receiving cavity 110 of the insulating body 1, they can be fixed by ultrasonic welding or by installing a shielding shell (not shown) outside the insulating body 1. However, the ultrasonic welding method or the actual assembly structure of the shielding shell is not a technical feature of the present invention, so no drawings or detailed descriptions are provided.

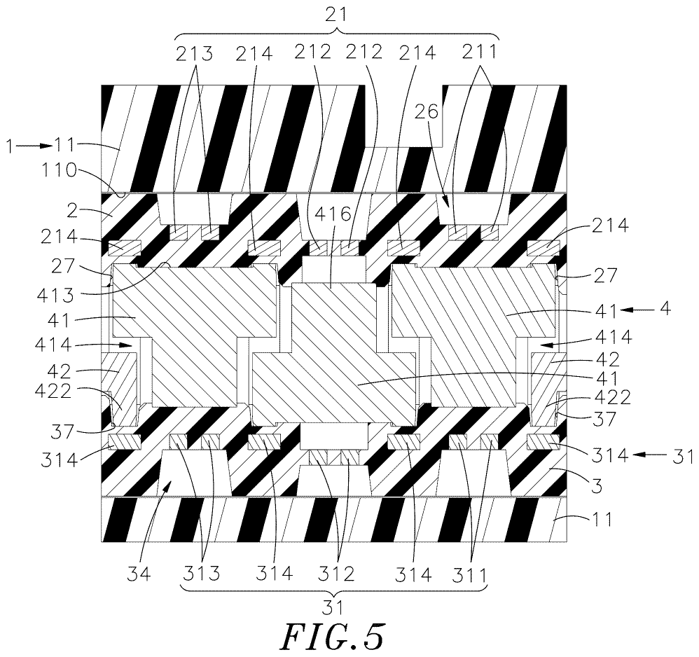

Please refer to FIGS. 3, 4 and 5, which disclose that the plurality of signal terminals (211, 212, 213, 311, 312, 313) in the first terminal block 2 and the second terminal block 3 have a plurality of hollow portions (26, 36) on the relatively outer sides, and the signal terminals (referring to the second signal terminals 212 and the fifth signal terminals 312) in the middle of the first terminal block 2 and the second terminal block 3 have hollow portions (26, 36) on the relatively inner and outer sides. The function of the hollow portions (26, 36) is to keep the signal terminals (211, 212, 213, 311, 312, 313) in contact with the air, and at the same time, the terminal air gap 413 and the channel air gap 414 of the plurality of conductive plastics 4 are used to form air diversion, thereby achieving the purpose of reducing the insertion loss and reflection loss during high-frequency operation. The relatively inner sides of the plurality of ground terminals (214, 314) in the first terminal block 2 and the second terminal block 3 are respectively coupled to the first abutting portions 412 of the first conductive plastics 41 to form a common grounding structure to improve the crosstalk and interference problems of the electrical connector during high-frequency signal transmission.

The main feature of the present invention is that the base portions (24, 34) and the fixing portions (25, 35) of the adjacent signal terminals of the first terminal set 21 and the second terminal set 31 form a staggered structure, which can increase the physical distance between the adjacent signal terminals. The farther the distance between the signal terminals, the lower the far-end crosstalk during high-frequency transmission, thereby achieving the purpose of producing an electrical connector structure with better high-frequency transmission characteristics.

The above is only a preferred embodiment of the present invention, and does not limit the patent scope of the present invention. Therefore, all simple modifications and equivalent structural changes made by using the contents of the description and drawings of the present invention should be included in the patent scope of the present invention and should be declared.

In summary, the structure of electrical connector of the present invention can achieve its effect and purpose when used, so the present invention is truly a creation with excellent practicality. In order to meet the application requirements for invention patents, we have filed an application in accordance with the law. We hope that the review committee will approve this case as soon as possible to protect the inventor's hard work in research and development. If the review committee has any questions, please feel free to write to us for instructions. The inventor will do his best to cooperate.

What the invention claimed is:

1. An electrical connector, comprising: an insulating body, and a first terminal set and a second terminal set disposed opposite to each other in said insulating body, wherein said first terminal set and said second terminal set each comprise a plurality of signal terminals and a plurality of ground terminals, said signal terminals and said ground terminals each comprising a connecting portion and a welding portion respectively located at two opposite ends, each of said signal terminals further comprising a wider base portion and a wider fixing portion located between said connecting portion and said welding portion, said base portions and said fixing portions of adjacent said signal terminals forming a staggered structure.

2. The electrical connector as claimed in claim 1, wherein said insulating body comprises a holder base, two plates located on one side of said holder base, a receiving cavity formed inside said holder base, a docking space formed between said two plates, a plurality of through slots formed between said holder base and said two plates for said first terminal set and said second terminal set to pass through, and a plurality of positioning grooves provided in said two plates for accommodating and positioning said connecting portions of said first terminal set and said second terminal set.

3. The electrical connector as claimed in claim 1, further comprising a first terminal block, wherein said first terminal set is inserted into said first terminal block, said first terminal set having said connecting portions thereof with a longer length and inserted into respective said through slots of said insulating body and said welding portions thereof with a shorter length located on two opposite sides of said first terminal block, the wider said base portions of said first terminal set being located between the respective said connecting portions and said first terminal block, said fixing portions of said first terminal set being embedded in said first terminal block, said signal terminals of said first terminal set being classified into a plurality of first signal terminals, a plurality of second signal terminals and a plurality of third signal terminals; first ground terminals of said first terminal set are respectively provided on two opposite sides of said first signal terminals, said second signal terminals and said third signal terminals.

4. The electrical connector as claimed in claim 3, wherein said first terminal block comprises a a plurality of hollow portions corresponding to said signal terminals of said first terminal set, and a plurality of recessed grooves at an inner side thereof corresponding to said first ground terminals of said first terminal set.

5. The electrical connector as claimed in claim 1, further comprising a second terminal block, wherein said second terminal set is inserted into said second terminal block, said second terminal set having said connecting portions thereof with a longer length and inserted into respective said through slots of said insulating body and said welding portions thereof with a shorter length located on two opposite sides of said second terminal block, the wider said base portions of said second terminal set being located between the respective said connecting portions and said second terminal block, said fixing portions of said second terminal set being embedded in said second terminal block, said signal terminals of said second terminal set being classified into a plurality of fourth signal terminals, a plurality of fifth signal terminals and a plurality of sixth signal terminals, second ground terminals of said second terminal set are respectively provided on two opposite sides of said fourth signal terminals, said fifth signal terminals and said sixth signal terminals.

6. The electrical connector as claimed in claim 5, wherein said second terminal block comprises a plurality of hollow portions corresponding to said signal terminals of said second terminal set, and a plurality of recessed grooves located at an inner side thereof corresponding to said second ground terminals of said second terminal set.

7. The electrical connector as claimed in claim 1, further comprising a plurality of conductive plastics disposed between said first terminal set and said second terminal set, said plurality of conductive plastics being all provided with abutment portions protrudingly coupled to said ground terminals of said first terminal set and said second terminal set, and air gaps formed adjacent to said signal terminals of said first terminal set and said second terminal set and between adjacent said plurality of conductive plastics.

8. The electrical connector as claimed in claim 7, wherein said plurality of conductive plastics are classified into a plurality of first conductive plastics located in the middle and a plurality of second conductive plastics located on two opposite sides, and air gaps are formed between adjacent said first conductive plastics and between said first conductive plastics and said second conductive plastics, and said first conductive plastics are arranged in a front and back staggered alternating structure.

9. The electrical connector as claimed in claim 8, wherein said first conductive plastics are in a “ [symbol] ” shape with a wider part and a narrower part, each said first conductive plastic comprising two first engaging portions respectively provided on two opposite sides of a bottom surface of the wider part to be inserted into said recessed grooves of one of said first terminal block and said second terminal block, a first abutting portion with a larger protrusion height formed at one end of each of said two first engaging portions and coupled to said ground terminals of said first terminal set and said second terminal set, a terminal air gap in a recessed shape formed between said two first engaging portions, a channel air gap formed on two sides of the narrower part thereof, and a contact surface and a positioning portion with a greater height formed on a top surface of the narrower part thereof.

10. The electrical connector as claimed in claim 8, wherein said second conductive plastics are in a long strip shape, each said second conductive plastic comprising a second engaging portion provided on a bottom side thereof to be inserted into one respective said recessed groove of one of said first terminal block and said second terminal block, and a second abutting portion with a larger protrusion height formed at one end of said second engaging portion and coupled to said ground terminals of said first terminal set and said second terminal set.
